(19) United States
(12) Patent Application Publication
(10) Pub. No.: US 2014/0311406 A1
(43) Pub. Date: Oct. 23, 2014

(54) METHOD AND APPARATUS FOR APPLYING PAINT ON BASICALLY FLAT PARTS

(71) Applicant: CEFLA SOCIETA' COOPERATIVA, IMOLA (IT)

(72) Inventors: RICCARDO BEDESCHI, LUGO (IT); ANDREA LUCA GUIDUZZI, MASSA LOMBARDA (IT); STEFANO CHIARINI, CONSELICE (IT)

(73) Assignee: CEFLA SOCIETA' COOPERATIVA, IMOLA (IT)

(21) Appl. No.: 14/255,767

(22) Filed: Apr. 17, 2014

(30) Foreign Application Priority Data
Apr. 22, 2013 (IT) BO2013A000182

(51) Int. Cl. B05B 15/12; B05D 1/02

(52) U.S. Cl. CPC B05B 15/1222; B05B 15/1292; B05D 1/02
USPC 118/323; 454/52; 454/53; 454/55; 118/326; 118/324; 427/424

(57) ABSTRACT

Spray booth (21) for applying paint on basically flat parts (22), said spray booth having a plenum (24) and comprising a conveying system (25) for conveying the flat parts (22) to be painted, at least a device (23) for applying paint on said moving parts, and at least a suction system, wherein the plenum (24) of the spray booth has a semi-cylindrical shape, having its axis perpendicular to the direction of the advancing part (22).

### CROSS REFERENCE TO RELATED APPLICATIONS

The present application claims priority to Italian Patent Application No. BO2013A000182 filed Apr. 22, 2013, the contents of which are expressly incorporated herein by reference.

### STATEMENT RE: FEDERALLY SPONSORED RESEARCH/DEVELOPMENT

Not Applicable.

### BACKGROUND OF THE INVENTION

The present invention relates to the technical field of apparatuses for applying paint on basically flat parts, known on the market as paint spray booths. In particular, the present invention relates to the shape of their plenum, wherein plenum means a ceiling able to distribute an airflow entering into a space.

Spray booths are known that apply spray paint through automatic devices (reciprocators, rotating spraying system, carousel-rotating system, gantry-robots, anthropomorphic robots) on parts to be painted.

Spray paint application entails that not all the paint hits the part to be painted; the paint not hitting flat parts partly hits the conveying system, and partly hovers in the air in the spray booth itself. This last portion of sprayed paint is called overspray, and is partially intercepted by spray booth suction system.

Non-intercepted overspray tends to contaminate spray booth internal walls, gathering on them up to the point of compromising manufacturing quality and leading to an important waste of painted parts. Therefore costly maintenance and cleaning of the spray booth itself become mandatory.

The overspray intercepted by the suction system is channeled towards spray booth filters, thanks to an air flow produced by the suction system itself, too. In this path the overspray is controlled in a more proper way thanks to the emission of an air flow from the plenum.

Examples of the prior art are U.S. Pat. No. 5,153,034 and US 2003/0183166 describing a paint spray booth having a sloping dual plenum, formed by two sloping plenums moving independently.

Another shape known in the prior art is a flat plenum, horizontal and parallel to the part to be painted, as disclosed in WO 0185357.

### SUMMARY OF THE INVENTION

The present invention seeks to provide a spray booth with an improved air circulation, controlling as much as possible the overspray. This can be obtained generating an air flow more congruent with the geometry of the whirl produced by the combined effect of spray guns and suction.

This object is achieved with the plenum of the present invention, which has a semi-circular section, generating an air flow perpendicular to its semi-cylindrical surface. The axis of the semi-cylinder is perpendicular to the conveying direction of the part to be painted within the spray booth.

The semi-cylindrical shape is as much as possible similar to the overspray whirl which is generated. The semi cylindrical plenum works so that the central superior plenum portion keeps low the whirl generated by suction system, while the lateral walls of the semi-cylinder are oriented towards the transversal axis of the spray booth along which the whirl develops. In this way, the whirl itself is compressed towards the center of the spray booth.

The advantages of the present invention are due to the improvement in the control of overspray flow. This has several consequences:
cleaner painting process, which, for the final user, translates into a lower number of wasted painted parts;
lower need of cleaning and maintenance of the spray booth;
lower air consumption to get overspray control (lower number of air renewals per time unit);
recovery of a higher paint quantity by suction system in the cases where paint can be re-used.

### BRIEF DESCRIPTION OF THE DRAWINGS

Further advantages and features of the present invention are disclosed in the following description, in which exemplary embodiments of the present invention are explained in detail on the basis of the enclosed drawings, showing:

FIGS. 1a and 1b is a view of a longitudinal section of two prior art examples having flat and sloping plenums, respectively;

FIG. 2 is a view of a longitudinal section of the present invention on the whole;

FIG. 3 is a view of a detail of a longitudinal section showing the air flow generated in the present invention;

FIG. 4 is an axonometric view of the air flow generated in the spray booth of the present invention.

### DETAILED DESCRIPTION OF THE INVENTION

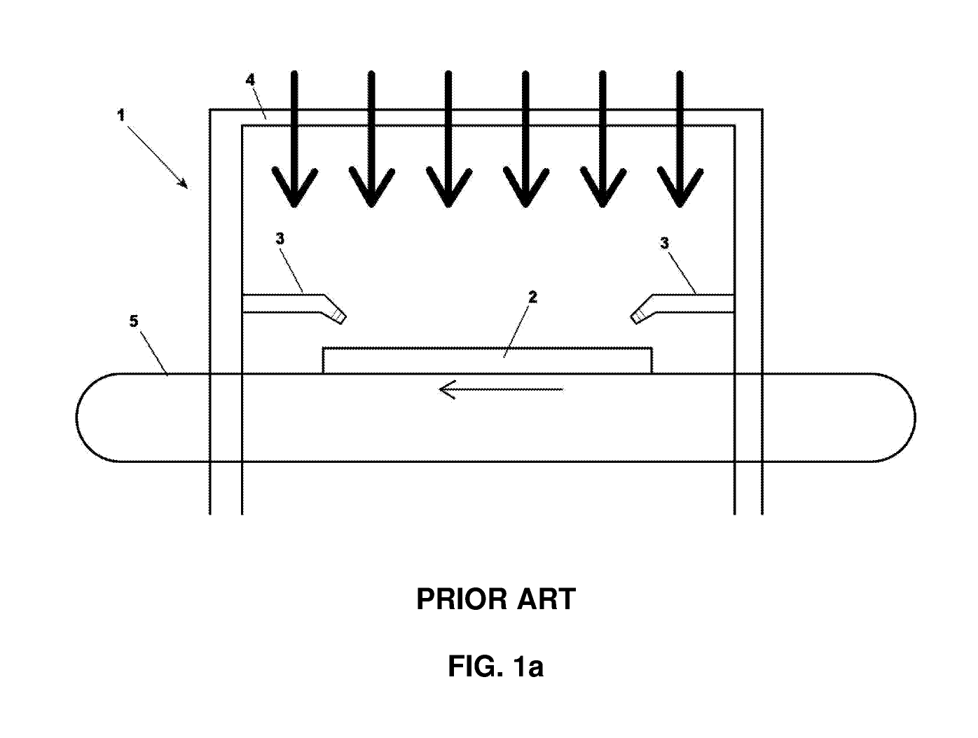

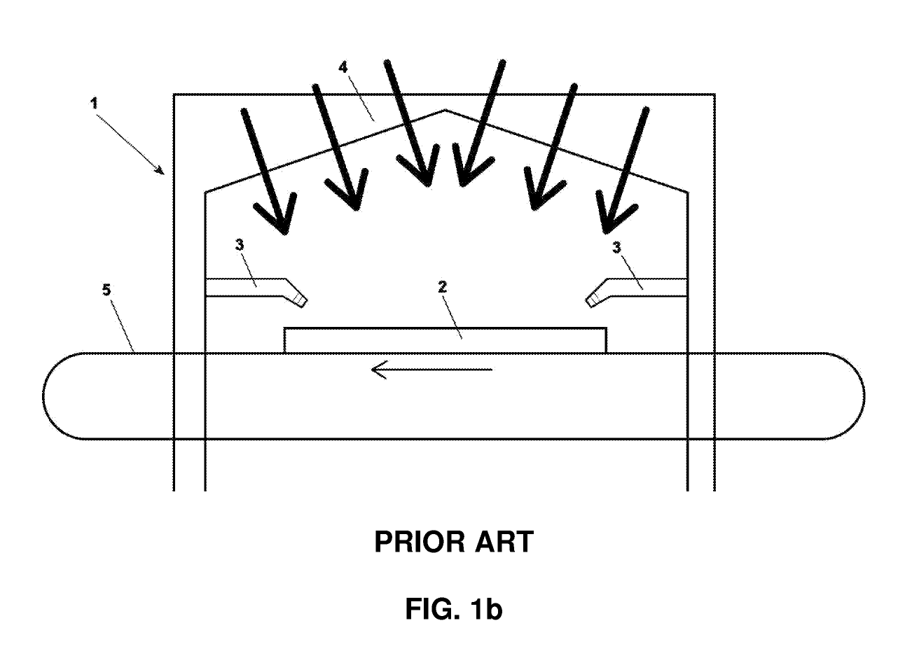

FIGS. 1a and 1b show on the whole a prior art spray booth 1, wherein a flat part 2 moves forward carried by conveying system 5; the thin arrow shows its direction. The flat part 2 is painted by spray guns 3. FIG. 1a shows a spray booth having a flat plenum 4, while FIG. 1b shows a spray booth having a sloping dual plenum 4. In both cases the bold arrows show the air flow coming from its plenum, respectively.

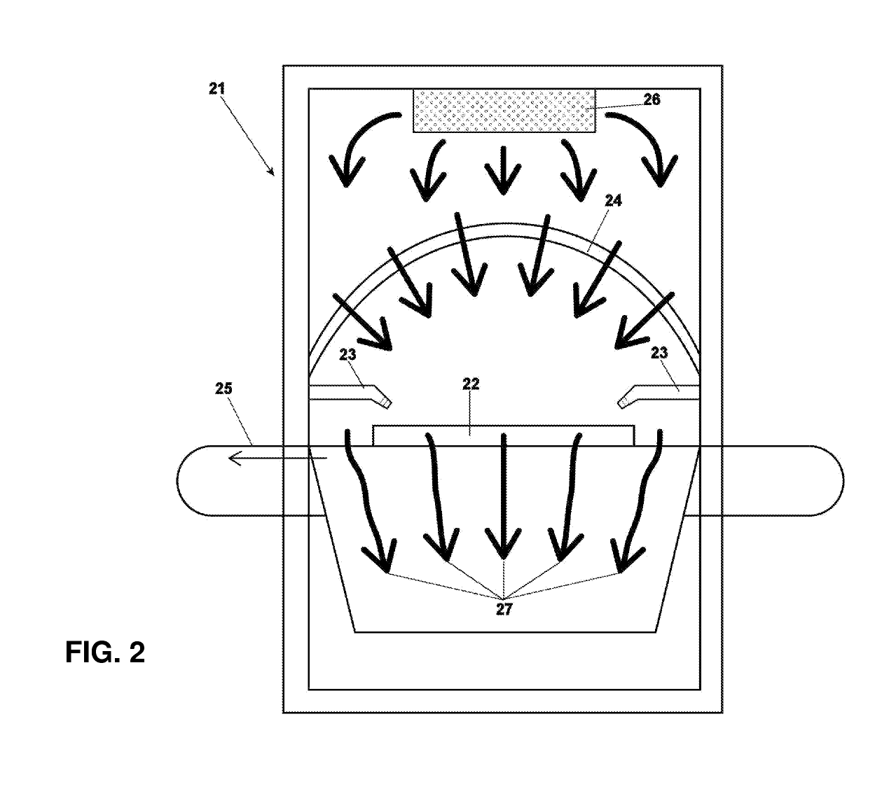

FIG. 2 shows a section of the spray booth 21 of the present invention along its longitudinal axis. The spray guns 23 spray paint on flat part 22 moving forward in the sense indicated by the thin arrow. The semi-cylindrical plenum 24 generates an air flow perpendicular to its semi-cylindrical surface, as shown by bold arrows. A diffuser 26 uniformly distributes air in an orderly way within spray booth 21; the diffuser 26 is upstream the semi-cylindrical plenum 24. The arrows 27 show the path of the overspray intercepted by suction and filtering system.

Upstream diffuser 26 there is optionally provided a device (not shown) for forcing air into spray booth 21, e.g. a fan or an independent device external to the spray booth itself.

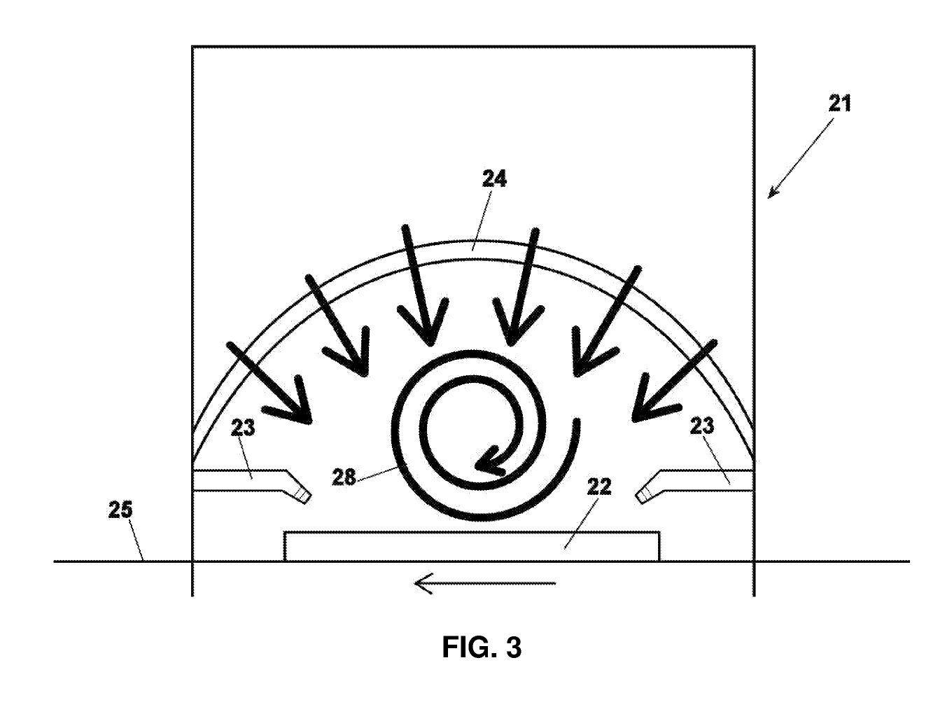

FIG. 3 shows a detail of an overspray whirl 28 generated in spray booth 21. The semi-cylindrical shape of plenum 24 allows to have a whirl 28 much easier controllable with respect to what occurs in the prior art spray booth, especially those having flat plenums.

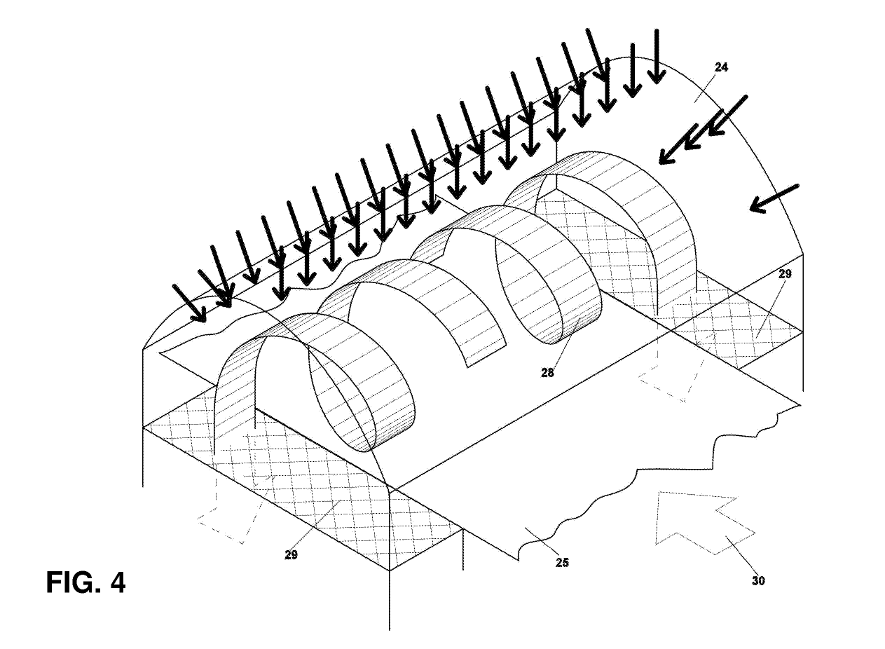

FIG. 4 shows an axonometric view of spray booth 21, wherein the top part of spray booth is not shown, for better clarity. White arrow 30 shows the direction of the advancing flat part, while whirling flow indicated as arrow 28 is indicatively shown, up to air inlet 29 on both sides of the conveying system 25. In fact a whirling flow 28 develops, having shape and dimensions similar to those of the semi-cylindrical plenum 24, and an axis perpendicular to the conveying direction 30 of parts 2. The black bold arrows show the path of the air flow controlled by diffuser 26.

When spray booth 21 is installed at the final user's premises, usually its parameters must be adjusted for painting process optimization. On one side the plenum geometry is essential, but according to the dimensions of the spray booth, the devices for applying paint, and especially the kind of paint, the air flow is to be adjusted in different ways.

As shown in in-house comparative tests, with the semi cylindrical plenum of the present invention the optimization of the parameters of spray booth 21 was surprisingly simpler and faster compared to the spray booth having different plenum.

Another advantage of the present invention is linked to suction system filter change. As a matter of fact, when filters are dirty, up to their removal the overspray control progressively deteriorates, and returns to optimal level when filters are changed. With the semi-cylindrical plenum of the present invention, the overspray control is much less sensitive to dirty accumulation on filters, leading to a steadier quality of the process.

What is claimed is:

1. Spray booth for applying paint on basically flat parts, said spray booth having a plenum and comprising a conveying system for conveying the flat parts to be painted, at least a device for applying paint on said moving parts, and at least a suction system, wherein
the plenum of the spray booth has a semi-cylindrical shape, having its axis perpendicular to the direction of the advancing part.

2. Spray booth according to claim 1, wherein the semi-cylindrical plenum is permeable to air, and wherein the direction of air flow is perpendicular to semi-cylindrical surface.

3. Spray booth according to claim 2, wherein at least a diffuser distributes uniformly air in the volume upstream semi-cylindrical plenum.

4. Spray booth according to claim 1, further comprising at least a device for forcing air into spray booth.

5. Spray booth according to claim 1, wherein the conveying system carrying flat parts is a belt conveying system.

6. Spray booth according to claim 1, wherein suction system comprises dry filters.

7. Spray booth according to claim 6, wherein suction system comprises water veil filters.

8. Spray booth according to claim 1, wherein the device for applying paint is chosen from the group comprising reciprocators, rotating system, carousel-rotating system, gantry robots, anthropomorphic robots.

9. Painting process making use of the spray booth having semi-cylindrical shape according to claim 1.
